(19) United States
(12) Patent Application Publication
(10) Pub. No.: US 2006/0058010 A1
(43) Pub. Date: Mar. 16, 2006

(54) Telecommunications

(76) Inventors: Michael Williams, Bristol (GB); Christopher Shaw, Bristol (GB)

Correspondence Address: Christopher M Tobin;Collier Shannon Scott, Suite 400, 3050 K Street NW, Washington, DC, 20007, US

(21) Appl. No.: 10/489,783

(22) PCT Filed: Sep. 19, 2002
(86) PCT No.: PCT/GB02/04262

§ 371 Date: May 18, 2005

(30) Foreign Application Priority Data
Sep. 21, 2001 (GB) 0122824.6

(51) Int. Cl. H04Q 7/38

(52) U.S. Cl. 455/414.1; 455/405; 455/411

(57) ABSTRACT

A computer-implemented method of determining rating data for use in rating a service requested to be provided to a subscriber of a telecommunications system, the method comprising the steps of: storing individual subscriber records relating respectively to individual subscribers of a telecommunications systems. storing, in a subscriber record relating to a subscriber, information for use in determining rating data for use in rating a service requested to be provided to the subscriber, the information identifying one or more parameters of a service; receiving a request to provide a service to the subscriber, and determining rating data for use in rating the requested service in dependence on the information if one or more parameters of the service requested match the service parameters identified in the information.

### FIELD OF THE PRESENT INVENTION

The present invention relates to telecommunications and, particularly but not exclusively, to computer-implemented methods of, data processing apparatus for, and computer programs for determining rating data for use in rating a service requested to be provided to a subscriber of a telecommunications system in a manner personalised to or specific to the subscriber.

### BACKGROUND

In the field of telecommunications, it is known to use data processing systems for rating a telecommunications service. For example, a public switched telephone network operator, which generates customer bills on a monthly basis, will typically have many millions of customers each making hundreds of telephone calls each month to various destinations around the world and at various times of day. Call Detail Records (CDRs) are generated for each call and sent to rating and billing systems for batch processing. The rating systems calculate the appropriate rate for each call, based on the time of day and call destination for example, and this is used by the billing systems to generate monthly bills.

Whilst public switched telephone network operators generally provide services to their customers on a contractual basis in which the customer receives a monthly bill for services provided during the previous month, other approaches to providing services are common. Operators of mobile radio telecommunication networks, such as those conforming to the GSM standards, typically provide services on a prepaid basis as well as on a postpay or contractual basis. A prepaid account balance is maintained by the mobile network for each prepaid subscriber who must pay in advance of using telecommunications services such as voice calls. Prepaid subscribers may buy vouchers to top up their account balances or transfer money directly by credit or debit card transactions, for example. Prepaid subscriptions provide benefits to the subscriber in that they entail no regular financial commitment unlike most contractual types of subscription. However, technical challenges are posed to network operators. For example, network operators must be able to rate telecommunications services to be provided to prepaid subscribers before actual provision of the service and must also be able to perform actions in respect of the service during the actual provision of the service, so that service provision may be denied or suspended if the subscriber has exhausted his or her prepaid balance. For example, the connection of a prepaid subscriber engaged in an expensive international call while roaming in a foreign network may need to be terminated during the call when the subscribers prepaid account balance has been exhausted in order to avoid potentially large debts arising.

In the field of mobile radio telecommunications, it is known to provide different types of subscriptions in which different tariffs or rates are applicable in respect of the various services available to a subscriber. For example, in contract-type subscriptions, where the subscriber is provided with an allocation of service usage on a periodic basis, the rates applicable to various services, such as voice calls not covered in the allocation, may differ depending on the value or type of subscription. Subscriptions with larger periodic allocations may have lower rates for voice calls made outside those allocations than subscriptions with smaller periodic allocations. Similarly, with prepaid subscriptions, where the subscriber purchases a voucher for a certain amount of money in advance of using the mobile networks services, the rate applied to various services may depend on the type or value of the voucher purchased by the subscriber. For example those subscribers purchasing a £50 voucher will enjoy better rates for voice calls than those purchasing a £10 voucher. To implement the latter scheme when rating calls made by a prepaid subscriber, it is known to store, in a database record holding subscriber information, data representing the type or value of the voucher currently active for the prepaid subscriber, thereby indicating a generally applicable tariff or rate class which may be used to look up a rate stored in a rating table generally applicable to all prepaid subscribers.

U.S. Pat. No. 5,960,416 describes a system for real-time subscriber billing at a subscriber location in an unstructured communication network. Network routing devices are disclosed comprising a processor for performing real-time billing calculations, memory means for storing detail use records (e.g. records detailing call usage), tariffs (which may be downloaded from a central office switch) and billing data (e.g. regarding the subscriber's useable balance). Service may be authorised or denied on the basis of the real-time billing calculations.

U.S. Pat. No. 6,044,259 discloses systems for implementing call- and subscriber-specific restrictions on services provided, which restrictions may be implemented in real-time. Thus, an intelligent node of a mobile telecommunications networks is provided with the real-time charges for a call and may perform further processes or functions, such as sending an alarm when accumulated charges reach a predetermined limit stored in a subscriber record, for example.

International publication No. WO 00/28746 discloses a system and method for charging an intelligent network subscriber for message communications. Thus, a prepaid subscriber of a GSM mobile network may be prevented from sending short messages when their account balance has fallen below zero.

In the field of fixed telephony, a supplementary service called “family and friends” is known in which subscribers of contract-type subscriptions are entitled to select 10 or so telephone numbers calls to which are discounted in the monthly bill. The processing involved in generating the discounted bill is performed after the CDRs relating to a subscriber's monthly calls have been rated in a conventional manner. Subscriber changes of telephone number selections for the service can normally only be made under certain temporal conditions, for example once every month prior to generation of the bill, partly because of the post-rating processing. Also, providing unrestricted selection would enable subscribers to select whatever number they intend to call next as a “family and friends” number and thus allow subscribers to obtain discounts on all calls made thus defeating the object of the service.

International Patent Publication No. WO 00/076225 describes a system for providing a called subscriber's station with a user interface means, such as a Wireless Application Protocol (WAP) card, for setting the called subscriber's supplementary services in respect of the calling subscriber's station identity. For example, on being called by a calling party, the called subscriber station receives a WAP card which enables the called subscriber to add the telephone number of the calling subscriber to a white or black list of telephone numbers. One of the supplementary services mentioned in this publication is “family and friends”. Thus, the called subscriber may add the telephone number of the calling subscriber to his or her “family and friends” list for use when making a call at a later time.

It is known to implement apparatus for sharing the cost of telephone calls between a calling and a called party. For example, International Patent Publication No. WO 98/40581 discloses a shared charging method by which a called subscriber is made to share only the telephone charges for the calls from calling subscribers in the charged area permitted by the called subscriber according to conditions designated by the called subscriber.

With the advent of more advanced and more numerous telecommunications services—such as text or multimedia messaging, voice or video conferencing, e-mail access, public or private data network access (such as intranet or Internet access), facsimile services, video and multimedia streaming services, and other data services (whether using a terminal-to-terminal, peer-to-peer or client/server model)—available to subscribers of mobile as well as fixed telecommunications networks, service plans or packages (and thus rating methods and systems) will become increasingly complex and will need to become increasingly adapted and personalised to the subscriber. Furthermore, telecommunications service providers offering these advanced services may offer them on either a contractual or postpay subscription basis or on a prepaid subscription basis. While some the above-described approaches of the prior art go some way to providing service packages or plans which may be adapted and personalised, a more general and flexible system is needed in which a variety of telecommunications services may be provided to suit the particular needs of the subscriber and, preferably, in which subscriber-specific rating of services may be implemented in telecommunications networks. The present invention provides such a system.

### SUMMARY OF THE PRESENT INVENTION

According to a first aspect of the present invention there is provided a computer-implemented method of determining rating data for use in rating a service requested to be provided to a subscriber of a telecommunications system, the method comprising the steps of:
storing individual subscriber records relating respectively to individual subscribers of a telecommunications system,
storing, in a subscriber record relating to a subscriber, information for use in determining rating data for use in rating a service requested to be provided to the subscriber, the information identifying one or more parameters of a service;
receiving a request to provide a service to the subscriber, and
determining rating data for use in rating the requested service in dependence on the information if one or more parameters of the service requested match the service parameters identified in the information.

Advantageously, the present invention allows a subscriber of a telecommunications system to be provided with a service which may be rated in a manner which is personalised to the subscriber or selected at least in part by the subscriber. The rating system is flexible, adaptable and is better suited to the needs of a variety of users of numerous or advanced services. Thus, service packages or plans may be better suited to the needs of subscribers of telecommunications systems.

In one embodiment, the service parameters identified in the information comprise a type of service. Thus, the personalisation in respect of the subscriber may differentiate between types of telecommunication service.

In a further or alternate embodiment, the service parameters identified in the information comprise a network address associated with the service, other than the network address of the subscriber. Thus, the personalisation in respect of the subscriber may differentiate between a telecommunications service provided in relation to different network addresses. For example, the personalisation may differentiate between terminal-to-terminal communication with different subscribers of the same or different telecommunications systems, or it may differentiate between accessing data resources at different locations whether on the same or on a different telecommunications systems.

In a further or alternate embodiment, the information identifies a specific rate for use in rating the service. Thus, the telecommunications system is easily able to determine a personalised rate for charging or billing purposes. Alternatively, the information identifies a specific discount from a generally applicable rate for use in rating the service. Thus, rates may be determined on the basis of personalised discounts from generally applicable rates.

In a further or alternate embodiment, the information identifies a party, other than the first subscriber, to whom at least part of a charge for providing the requested service is to be applied. Thus, the personalisation may extend to charging or billing a party other than the subscriber for provision of service, at least in part.

Preferably, the determining is performed during processing of the service request, or during provision of the service. Thus, rating and various processes dependent on rating data may be performed in real-time.

In one embodiment, the telecommunications system maintains an account balance for the subscriber and the method comprises generating charging data for applying to the subscriber's account balance in dependence on data including the determined rating data. Preferably, the charging data is S generated and applied to the subscriber's account balance before or during provision of the requested service. Thus, a service may be provided to and charged to a subscriber.

In a further or alternate embodiment, the telecommunications system maintains an account balance for the other party and the method comprises generating charging data for applying to the other party's account balance in dependence on data including the determined rating data. Preferably, the charging data is generated and applied to the other party's account balance before or during provision of the requested service. Thus, a service may be provided to a subscriber and charged at least in part to another party.

Preferably, the method comprises the step of determining whether or not to provide or continue to provide the requested service to the subscriber in dependence on data including the determined rating data Thus, services offered at personalised rates may be provided to prepaid subscribers to whom the telecommunications network must be able to deny or suspend provision of the service depending on the personalised rate.

Preferably, when the requested service is a metered service, the method comprises determining a frequency for applying the charging data in dependence on data including the determined rating data. Thus, the telecommunications system may perform the data processing steps necessary to apply charges to the subscriber's or other party's account in an efficient manner which takes into account the personalised rate.

In one embodiment, the method comprises the step of generating a message for sending to a terminal of the subscriber in dependence on data including the determined rating data. Thus, a subscriber receiving a service with a personalised rate may be informed of the rate currently applicable to the service or other related information.

In another embodiment, the method comprises the step of generating a message for sending to a terminal of the other party in dependence on data including the determined rating data. Thus, the other party may be informed of a rate or charge being applied to him or her in respect of a service provided to the subscriber.

Preferably, the message for sending to a terminal of the other party provides user interface means for determining whether or not to provide or continue to provide the requested service to the subscriber. Thus, the other party may cause the denial or suspension of service provision to the subscriber.

In preferred embodiments, the data including the determined rating data further includes a value of the subscriber's account balance and, in further preferred embodiments, the data including the determined rating data further includes the other party's account balance. Thus, the telecommunications system may determine whether or not to provide or continue to provide the requested service to the subscriber not only depending on the subscriber's account balance, but also the account balance of the other party, who may be a prepaid subscriber. Also, the telecommunications system may perform the data processing steps necessary to apply charges to the subscriber's or other party's account in a yet more efficient manner which takes into account the account balance of the subscriber or other party. Also, a message generated for sending to a terminal of the subscriber or other party may include the account balance of the subscriber or other party or related information.

According to a second aspect of the present invention there is provided a data store for storing information for use in determining rating data for use in rating a service requested to be provided to a subscriber of a telecommunications system, the data store storing the information in individual subscriber records relating respectively to individual subscribers of a telecommunications system, the information identifying one or more parameters of a service and being for use in determining rating data for use in rating a service requested to be provided to the subscriber to which the information relates if one or more parameters of the requested service match the service parameters identified in the information.

According to a third aspect of the present invention there is provided a data processor for determining rating data for use in rating a service requested to be provided to a subscriber of a telecommunications system, the data processor comprising:
means for accessing information stored in individual subscriber records relating respectively to individual subscribers of a telecommunications system, one of the subscriber records comprising information for use in determining rating data for use in rating a service requested to be provided to a subscriber and identifying one or more parameters of a service;
means for receiving data relating to a service requested to be provided to the subscriber, and means for determining rating data for rating the requested service in dependence on the information if one or more parameters of the service requested match the service parameters identified in the information.

According to a fourth aspect of the present invention there is provided memory for storing data for access by a program being executed on a data processing system, the memory comprising:
a data structure stored in the memory, the data structure including information for use in determining rating data for use in rating a service requested to be provided to a subscriber of a telecommunications system, the information being stored in individual subscriber records relating respectively to individual subscribers of a telecommunications system, the information identifying one or more parameters of a service and being for use in determining rating data for use in rating a service requested to be provided to the subscriber to which the information relates if one or more parameters of the requested service match the service parameters identified in the information.

According to a fifth aspect of the present invention there is provided a method of rating a service requested to be provided to a subscriber of a telecommunications system, the rating being performed on a per-subscriber basis, the method comprising the steps of:
selecting a subscriber of the telecommunications system;
selecting one or more parameters of a service which the telecommunications system is able to provide to the subscriber;
selecting rating data to be used when rating the service in respect of the subscriber;
generating information on the basis of the one or more parameters and the rating data;
providing a data store for storing individual subscriber records relating respectively to individual subscribers of the telecommunications system;
storing the information in a record of a data store relating to the selected subscriber,
receiving a service request to provide a service to the subscriber
determining rating data for rating the requested service in dependence on the information if one or more parameters of the requested service match the one or more service parameters stored in the subscriber's record,
rating the requested service in dependence on the determined rating data

According to a sixth aspect of the present invention there is provided apparatus for determining at least part of the rating data to be used in rating a telecommunications service potentially or actually provided to a subscriber of a telecommunications network, the apparatus comprising: an input data link for receiving data relating to the potential or actual provision of a telecommunications service to a subscriber; a data store for storing information for rating the service, the information being specific to the subscriber and to a parameter of the service, and a processor arranged to determine determining at least part of the rating data to be used in rating the service in accordance with the information.

According to a seventh aspect of the present invention there is provided a method determining at least part of the rating data to be used in rating a telecommunications service potentially or actually provided to a subscriber of a telecommunications network, the method comprising the steps of: receiving data relating to the potential or actual provision of a telecommunications service to a subscriber, accessing information stored in a data store, the information being determining at least part of the rating data to be used in rating the service and being specific to the subscriber and to a parameter of the service; and determining at least part of the rating data to be used in rating a service in accordance with the information.

According to an eighth aspect of the present invention there is provided a method of rating a telecommunications service potentially or actually provided to a subscriber of a telecommunications network, the method comprising the steps of: selecting one or more parameters of a telecommunications service to be potentially or actually provided to a subscriber, selecting a rate to be applied when rating the telecommunications service in respect of the subscriber, generating data for use in rating the telecommunications service in dependence on the selected one or more parameters and the selected rate; storing the data in a data store of the network such that the data is associated with the subscriber; and rating the service potentially or actually provided to the subscriber in accordance with the data, the rating being performed by a rating processor of the network.

Other aspects of the present invention are set out in the accompanying claims. Advantages of aspects of the present invention, other than the first aspect, are as described above, or similar to those described above, in relation to the first aspect Computer programs and apparatus for performing the methods of the first, seventh and eighth aspects of the present invention are also provided.

There now follows, by way of example only, a detailed description of preferred embodiments of the present invention in which: Brief description of diagrams

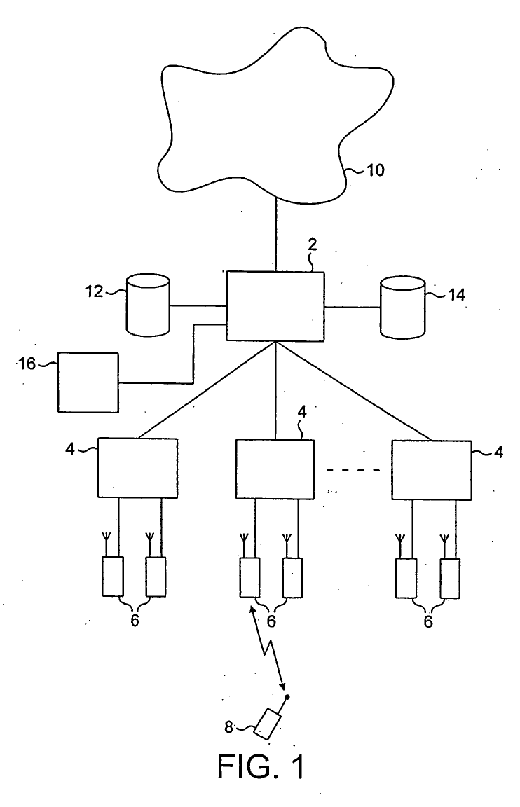

FIG. 1 is a block diagram schematically illustrating a mobile communications network;

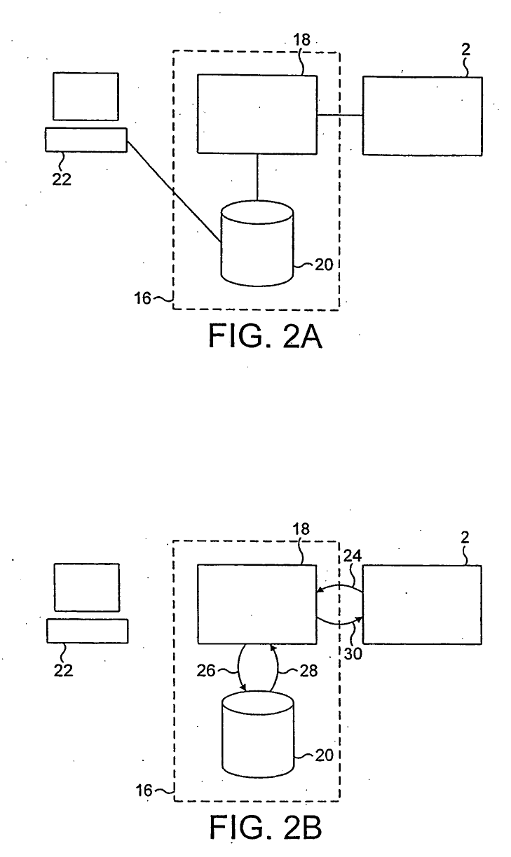

FIG. 2A is a block diagram schematically illustrating an arrangement of data processing and storage functions for rating and handling provision of a telecommunications service according to the present invention;

FIG. 2B is a block diagram schematically illustrating data flows occurring between the data processing and storage functions of FIG. 2A;

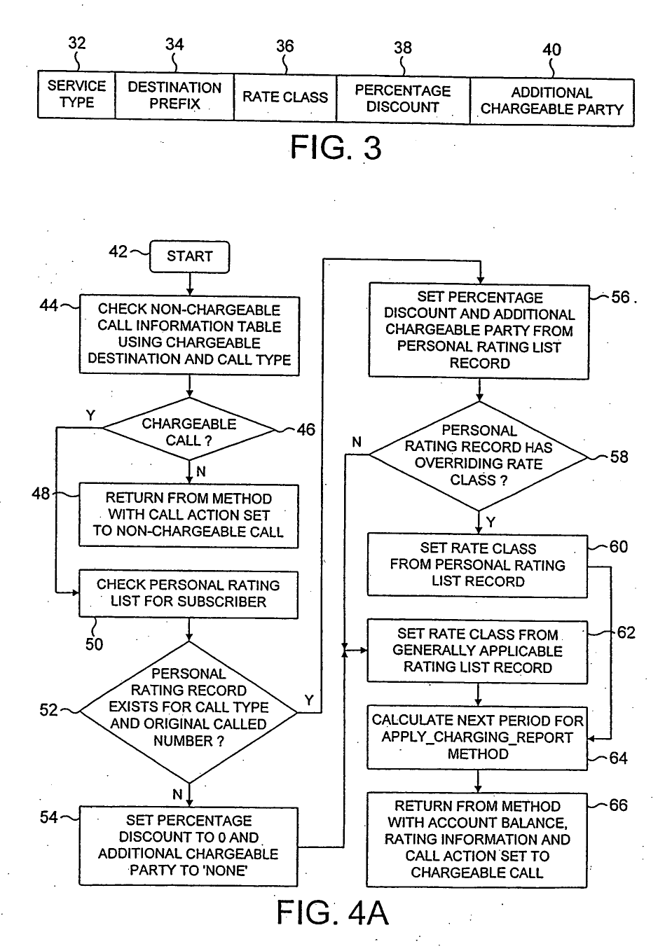

FIG. 3 is a data structure diagram showing the format of a data record maintained in respect of a subscriber for rating the provision of a telecommunications service according to the present invention;

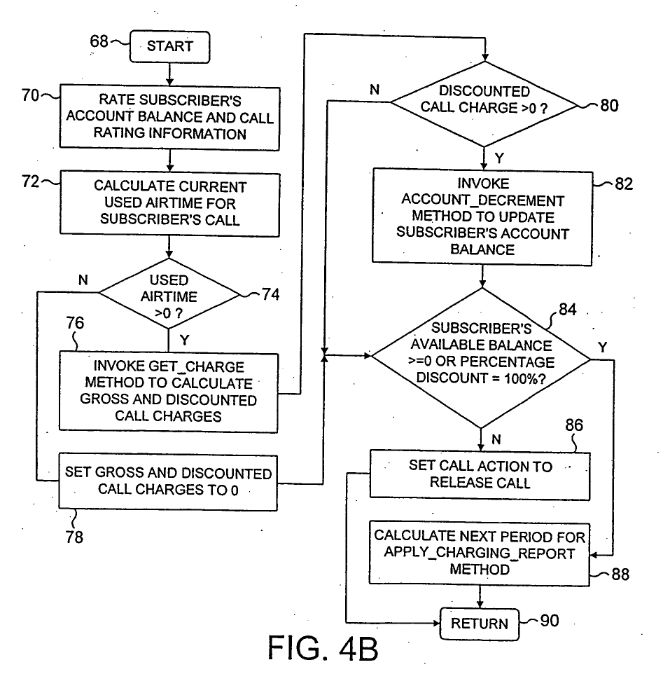

FIGS. 4A and 4B are a flow diagram showing the processes performed by a processor for rating and handling provision of a telecommunications service in accordance with the present invention;

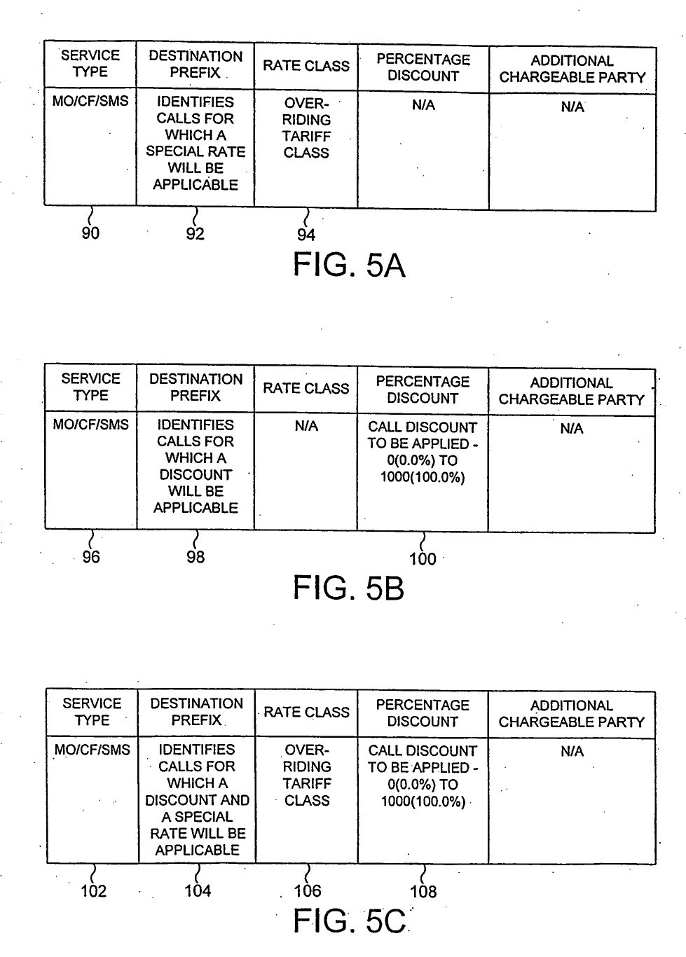

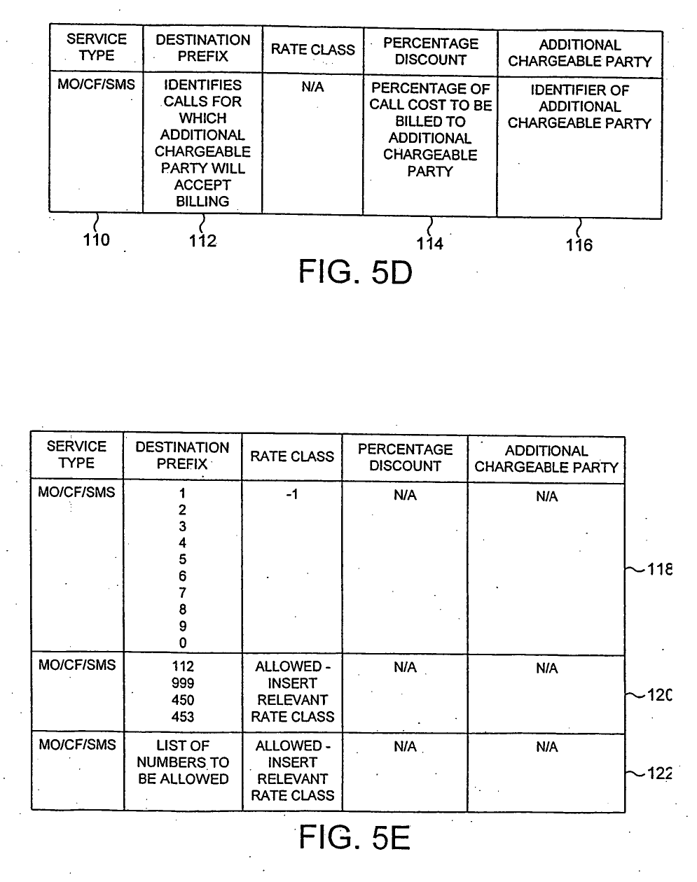

FIG. 5A to 5E are data structure diagrams showing example data record formats for implementing particular schemes for rating a telecommunications service provided to a subscriber in accordance with the present invention.

### DETAILED DESCRIPTION OF PREFERRED EMBODIMENTS OF THE INVENTION

FIG. 1 shows a cellular communications network, such as a GSM network, which is in itself known and will not be described in detail. A mobile switching centre (MSC) 2 is connected via communications links to a number of base station controllers (BSCs) 4. The BSCs 4 are dispersed geographically across areas served by the MSC 2. Each BSC 4 controls one or more base transceiver stations (BTSs) 6 located remote from, and connected by further communications links to, the BSC. Each BTS 6 transmits radio signals to, and receives radio signals from, mobile stations 8 which are in an area served by that BTS. That area is referred to as a “cell”. A mobile communications network is provided with a large number of such cells, which are ideally contiguous to provide continuous coverage over the whole network territory.

The MSC 2 is also connected via communications links to other MSCs, which are not illustrated, in the remainder of the communications system 10, and to a public switched telephone network (PSTN), public data network (such as the Internet), etc, which are not illustrated The MSC is provided with a home location register (HLR) 12 which is a database storing subscriber authentication data, and a visitor location register (VLR) 14 which is a database temporarily storing subscriber authentication data for mobile stations active in its area MSC 2 is capable of handling service provision for both postpay or contract subscribers and prepaid subscribers of the network in the area it serves. Thus, subscribers may originate or receive multimedia, video, voice, data or fax calls or sessions, short messages using the Short Message Service (SMS), email messages, enhanced or multimedia messages, and may access data resources over private or public data networks such as the Internet. Signalling and data in respect of services provided to mobile stations 8 is routed via MSC 2.

FIG. 2A is a block diagram schematically illustrating an arrangement of data processing and storage functions for handling or controlling provision of and rating a telecommunications service according to the present invention. Intelligent Network (IN) is used to control the provision of services to prepaid subscribers of the network architectures and protocols are well-known and will not be described in detail. In respect of service provision to prepaid subscribers using mobile stations 8, MSC 2 functions as a Service Switching Point (SSP) and is connected to and controlled by Service. Control Point (SCP) 16 with which it communicates using the Intelligent Network Application Protocol (INAP). The specification of INAP is provided in European Telecommunications Standards Institute (ETSI) standard ETS 300 374-1 incorporated herein by reference.

SCP 16 comprises a Prepaid Control Function (PCF) 18 connected to a Service Data Function (SDF) 20. PCF 18 is connected to MSC 2 with which it communicates using INAP as described above and is responsible for performing the data processing steps required to control the operation of MSC 2. SDF 20 is responsible for storing data relating to prepaid subscribers, such as prepaid account balance data for a subscriber, instance data relating to services currently being provided to a prepaid subscriber, and, according to the present invention, personalised rating information for a subscriber (to be described in detail below). SDF 20 is responsible for the data processing steps required to be provided in respect of a prepaid subscriber (to be described in detail below). SDF 20 is connected to user terminal 22 for user entry and amendment of data stored in respect of a prepaid subscriber, such as the personalised rating information. The personalised rating data stored in SDF 20 may also be entered or amended by means of being connected to a mobile station 8 via data or signalling channels. The mobile station user interfaces described in International Patent Publication No. WO 00/076225 referred to above may be used for this purpose.

Although FIG. 2 shows only one MSC 2, one SCP 16 and one user terminal 22, it will be understood that implementations will normally involve multiple physical data processing devices performing each of these functions. The data processing devices may be connected together through a signalling data network comprising one or more signalling transfer points (STPs) which provide packet-switching for the signalling network using the Signalling System 7 (SS7) protocol stack.

FIG. 2B is a block diagram schematically illustrating data flows occurring between the data processing and storage functions of FIG. 2A. Typically, MSC 2 passes an INAP request message 24 to PCF 18 requesting instruction in respect of a new or ongoing provision of a service to a prepaid subscriber. The request message normally provides information concerning the service and the identity of the subscriber. PCF 18 determines how to handle the request on the basis of the service information provided by MSC 2, on the basis of generally applicable information concerning service provision and on the basis of characteristics or information concerning the prepaid subscriber which are obtained by invoking a method of SDF 20 using request message 26 and receiving response message 28. PCF 18 then passes an INAP response message 30 back to MSC 2 instructing it to perform an action.

FIG. 3 is a data structure diagram showing the format of a data record maintained in respect of a subscriber for determining rating data for rating a telecommunications service in accordance with the present invention. SDF 20 may store one or more such data records containing personalised rating information in respect of one or more prepaid subscribers. Thus, SDF 20 may store a list of data records specific to a subscriber, each containing personalised rating information. The format of each data record of a list comprises five fields as shown in FIG. 3: field 32 representing a service type, such as a mobile originated (MO) calls, call forwarded (CF) calls or SMS messages; field 34 representing a network destination number or prefix, such as full telephone number, country or area prefix code or network operator prefix code; field 36 representing an overriding rate class (or simply an overriding rate) which may be used instead of the generally applicable rate class (or rate) which would normally apply to the service type and destination number or prefix (the data stored in field 36 will typically identify a rate or rate class stored in a separate data record or table and rates win typically be expressed as a monetary charge per unit of service, e.g. pence per second of call time or per SMS message); field 38 representing a percentage discount from a rate generally applicable for provision of the service expressed as a decimal number between 0 and 1000 (representing 0.0% to 100.0%); and field 40 representing an identifier of another party, such as the telephone number of another subscriber of the network, whether contract or prepaid, an email address of a party, or bank/financial account details (such as account number, credit or debit card details) of another party who the network is able to charge. Field 40 is optional in any data record. However, in the present embodiment, fields 32 and 34 and at least one of fields 36 or 38 are mandatory in any data record. Specific examples of data records for implementing particular rating schemes win be described in detail below with reference to FIGS. 5A to 5E.

In respect of metered services, such as voice calls, in which charges are determined based on a measurement of a parameter of the service, such as the duration of the service, there are two main types of processing performed by SCP 16: initial service processing and ongoing chargeable service processing. For example, on being required to set up a new voice call, MSC 2 passes a Determine_Call_Action INAP request message to PCF 18 requesting instruction on how to handle the call request and providing data including the telephone number of the prepaid subscriber requesting the call, and information concerning the call requested, such as the original called number, chargeable destination number (for example, if the call is forwarded) and the call type (mobile originated or cal1 forwarded). Using the information provided, PCF 18 invokes a Get_Call_Action method of SDF 20 to determine how to handle the call request, whether or not it is to be charged for, and to determine a rate class if the call is to be connected as a chargeable call. The Get_Call_Action method may determine that the call is to be released or connected to a specified telephone number, such as that of a Customer Service Representative (CSR) or Interactive Voice Response (IVR) unit. Alternatively, the Get_Call_Action method may determine that the call is to be connected as requested, either as a chargeable or non-chargeable call. SDF 20 maintains a Non-Chargeable Call Information Table which is generally applicable to all prepaid subscribers and stores information indicating whether a call is chargeable or free depending on chargeable destination and call type. SDF 20 also maintains a Generally Applicable Rating Table which is also common to all prepaid subscribers and contains the normally applicable chargeable rates depending on chargeable destination and call type.

FIG. 4A is a flow diagram showing the data processing steps performed by SCP 16 when performing the Get_Call_Action method to determine how to handle the call request, whether or not it is to be charged for, and to determine a rate class if the call is to be connected as a chargeable call. The process starts at step 42. At step 44, the Non-Chargeable Call Information Table is checked using the chargeable destination and call type provided by MSC 2 in the Determine_Call_Action INAP request message. The process continues to step 46 where it is determined, depending on the result of step 44, whether the call is chargeable or non-chargeable. If non-chargeable, the process continues to step 46 where the Call Action parameter is set to ‘non-chargeable call’ and the method terminates. This results in an INAP Connect response message being passed to MSC 2 instructing it to connect the call as a non-chargeable call.

However, if it is determined that the call is chargeable, the process continues to step 50 where the personalised rating information list, maintained by SDF 20, is checked in respect of the subscriber. The process continues to step 52 where it is determined whether a personalised rating data record exists for the subscriber in respect of the call type and original called number provided by MSC 2 in the Determine_Call_Action INAP request message. If a personalised rating data record does not exist, the process continues to step 54 where the Percentage Discount parameter is set to zero and the Additional Chargeable Party parameter is set to ‘None’. The process then continues to step 62 to be described below.

However, if a personalised rating data record does exist for the call type and original called number provided by MSC 2, the process continues to step 56 where the Percentage Discount parameter and Additional Chargeable Party parameter are set to the values prescribed in the personalised rating data record entry for the subscriber. The process then continues to step 58 where it is determined whether the personalised rating data record contains an overriding rate class or not. If yes, the process continues to step 60 where the Rate Class parameter is set to the overriding rate class contained in the personalised rating data record for the subscriber and the process then continues to step 64 to be described below. If not, the process continues to step 62 where the Rate Class parameter is determined by consulting the Generally Applicable Rating Table maintained in SDF 20 using the chargeable destination and call type provided by MSC 2 in the Determine_Call_Action INAP request message. The process then continues to step 64.

At step 64, the period before the first Apply_Charging Report method is to be performed is calculated The Apply_Charging_Report method is part of the ongoing service processing performed by SCP 16 and will be described below. The period before the first and between subsequent performing of the Apply_Charging_Report method is calculated during provision of a metered service, such as a voice call, so as to determine the frequency at which charging for provision of the service is to be performed The process of calculation will not be described in detail here but, in brief, it is dependent on either the personalised or generally applicable rate for provision of the service, and upon the current account balance of the prepaid subscriber. Thus, the Apply_Charging_Report method may be performed relatively infrequently when there are ample prepaid funds in the subscriber's account balance and relatively frequently when the subscriber's prepaid balance approaches zero or some other specified level, for example.

The process then continues to step 66 at which the method terminates with the Call Action parameter set to ‘chargeable call’, with the account balance, and with the various parameters set as described above. This results in an INAP Apply_Charging response message being passed to MSC 2 instructing it to connect the call as a chargeable call and to generate an INAP Apply_Charging_Report request message after the calculated period has expired (unless the call is terminated early, for example by the subscriber ending the call, in which case an Apply_Charging_Report request message may be generated earlier and will include the unexpired charging period remaining).

FIG. 4B is a flow diagram showing the data processing steps performed by SCP 16 when performing Apply_Charging_Report processing for ongoing chargeable calls. MSC 2 passes to PCF 18 an INAP Apply_Charging_Report request message after the calculated charging period has expired or earlier. This results in SCP 16 performing processing to apply rated charges for the call, and determine whether or not the prepaid subscriber has sufficient prepaid balance to continue the call. The process starts at step 68. At step 70, the prepaid subscriber's account balance and the rating information for the call (determined by the Get_Call_Action method processing described above) are read from the instance data for the ongoing call. The process then continues to step 72 where the airtime used since the Apply_Charging_Report processing was performed (or since the start of the call if this is the first such processing) is calculated as the charging period sent in the last Apply_Charging response message minus the unexpired charging period information sent in the Apply_Charging_Report request message (if any). The process continues to step 74 where it is determined if the airtime used is greater than zero. If not; the process continues to step 78 where the Gross Call Charge and Discounted Call Charge parameters are set to zero. The process then continues to step 84 to be described below.

However, if at step 72 it is determined that the used airtime is greater than zero, the process continues to step 76 where the Get_Charge method of SDF 20 is invoked to calculate the Gross Call Charges and Discounted Call Charges on the basis of the used airtime, start of call time, rate class (which may be a personalised rate class for the prepaid subscriber) and percentage discount (if any). The Get_Charge method is a simple arithmetic operation performed on the basis of the identified rate, the used air time and the percentage discount (if any) and will not be described further here. The process then continues to step 80 where it is determined whether or not the Discounted Call Charge is greater than zero. If not, the process continues to step 86 to be described below. If the Discounted Call Charge is greater than zero, however, the process continues to step 82 where the Account_Decrement method of SDF 20 is invoked to apply the Discounted Call Charge to the subscriber's prepaid account balance. Again, the Account_Decrement method is a simple arithmetic operation and will not be described further here. The process then continues to step 84.

At step 84, it is determined whether the prepaid subscriber's currently available account balance is greater than zero or the percentage discount is 100%. If not, i.e. if the subscriber's currently available balance is less than or equal to zero and the percentage discount is less than 100%, the process continues to step 86 in which the Call Action parameter is set to ‘release call’. The process then continues to step 90 where it terminates. This causes SCP 16 to generate an INAP Release Call response message for sending to MSC 2, resulting in the call being terminated due to lack of available prepaid funds. However, if the subscriber's currently available balance is greater than zero or the percentage discount is 100%, the process continues to step 88 where the period before performing the next Apply_Charging_Report method is calculated as described above. This results in an INAP Apply_charging response message being passed to MSC 2 instructing it to continue the call and to generate an INAP Apply_{—Charging}_Report request message after the calculated period has expired, or earlier as described above.

When the call is finished, either because of user or network termination, a CDR is generated by PCF 18 and stored in SDF 20 detailing, amongst other things, the subscnber's chargeable account, call type, the original called number and chargeable destination, the start and end time and date of the call, call duration, the rate class and percentage discount of the call, the total discounted, gross call charges and the additional chargeable party identifier. This CDR may be used for determining the charges to be applied to the other chargeable party, if any, in the case where the other chargeable party does not need to be charged during provision of the service. For example, this may be the case if the network provides the other chargeable party with a postpay or contract-type subscription, financial services such as a bank account, or has some other means of levying charges against the other chargeable party.

In the case where the network needs to apply charges to the other chargeable party during provision of the service, for example where the network provides the other chargeable party with a prepaid subscription and applies the balance of the charges for provision of the service to the other chargeable party's prepaid account balance, the following further processes may be performed. Firstly, during initial service processing of the service request, it is determined whether the service, for example a voice call, is chargeable to the other chargeable party and whether the charges are to be applied to a prepaid account balance of the other chargeable party (i.e. if the telephone number of the other chargeable party stored in field 40 corresponds to a prepaid subscription). If so, PCF 18 sets up a pseudo MSC function which mimics an MSC handling service provision to the other chargeable party (although no service is actually provided) and creates pseudo call instance data for a fictional call chargeable to the other chargeable party. Ongoing chargeable service processing for the fictional call follows a similar process as that described above in relation to FIG. 4A. However, the percentage discount used to determine rates or call charges is 100% minus the percentage discount determined during initial service processing of the actual call request. Thus, the charges applied to the other chargeable party's prepaid account balance are the balance of the charges applied to the original chargeable party. If part of the charges for the service are to be applied to the original subscriber and part to the other chargeable party, ongoing chargeable service processing is performed in respect of the psuedo call in parallel to ongoing chargeable service processing for the actual call. Ongoing chargeable processing for the actual call and for the psuedo call is linked so that termination of one, due to user termination of the call or network termination as a result of insufficient funds, results in termination of the other. If, however, all of the charges are to be applied to the other chargeable party, then ongoing service processing need be performed in respect of the other chargeable party only.

Other actions in respect of charging the other chargeable party for provision of the service may be performed, such as sending messages to the other chargeable party's mobile station informing him or her that the charges are to be applied or are being applied in respect of service being provided to the original chargeable party, or that his or her account balance has dropped below a predetermined threshold. The message sent to the other chargeable party's mobile station may provide user interface means allowing the other chargeable party to control the service to be or being provided to the original chargeable party. For example, the other chargeable party may be sent an initial WAP card or HTML (Hypertext Mark-Up Language) page describing the service requested and requesting whether or not to allow the service to be provided. Subsequent WAP cards or HTML pages may be sent during provision of the service detailing the costs incurred so far by either or both parties and providing user interface means for terminating provision of the service. CDRs may be generated in respect of the psuedo call in a similar manner to those generated in respect of the actual call. Thus, reports may be generated for the other chargeable party detailing the charges made in respect of the provision of the service to the original party.

Thus, it can be seen that with metered services, such as voice calls, the present invention permits personalised rating information to be utilised when handling a service both on initial service processing and during ongoing chargeable service processing for prepaid subscribers. Furthermore, various actions may be taken in respect of a service, before, during or after provision of the service in dependence on personalised rating information for a prepaid subscriber. For example, provision of the service may be denied or suspended due to insufficient prepaid funds, the frequency of application of charges (whether to the party receiving the service or another chargeable party) may be determined, and messages may be generated and sent to various parties.

With unmetered services, such as SMS messages, in which charges are determined independently of any measurement of a parameter of the service other than that the service is to or has been performed, processes similar to those described in relation to FIGS. 4A and 4B may be used to determine personalised rating information for use in handling the service. Briefly, on receipt of a request message from MSC 2, SCP 16 will check the personalised rating list for the subscriber to see if an entry applies for the unmetered service requested, and determine a personalised or generally applicable rate class, percentage discount (if any), and other chargeable party (if any) accordingly. The SCP will then calculate the Gross and Discounted Call Charges for provision of the service, determine whether or not the subscriber's prepaid balance (and/or other chargeable party's prepaid balance) is sufficient to allow for provision of the service and instruct MSC 2 accordingly. Thus, it can be seen that with unmetered services, the present invention permits personalised rating information to be utilised when handling a service on initial service processing for prepaid subscribers. Furthermore, various actions may be taken in respect of a service, before or after provision of the service in dependence on personalised rating information maintained for a prepaid subscriber. For example, provision of the service may be denied due to insufficient prepaid funds, and messages may be generated and sent to various parties.

FIG. 5A to 5E are data structure diagrams showing example data record formats for implementing particular schemes for determining rating data for rating a telecommunications service provided to a subscriber in accordance with the present invention. FIG. 5A shows the format of a data record entry for providing special call rates. Service type field 90 specifies the type or types of service for which the special rate is to apply, destination prefix field 92 identifies the destination prefix or number for which the special rate is to apply, and rate class field 94 defines the special rate. For example, a ‘local calling’ rate may be provided for calls made to the same National Number Group (NNG) as the subscriber's fixed telephone or a selected NNG.

FIG. 5B shows the format of a data record entry for providing discount call rates. Service type field 96 specifies the type or types of service for which the discount rate is to apply; destination prefix field 98 identifies the destination prefix or number for which the discount rate is to apply, and percentage discount field 100 defines the discount from the generally applicable rate. For example, a ‘family and friends’ type supplementary service may be provided by providing such an entry for each of limited number of destination numbers for which a ‘family and friends’ discount is to be applied.

The special rate scheme may be combined with the discount call rate scheme, for example where a ‘family and friends’ member is also a ‘local call’. This is shown in FIG. 5C in which service type field 102 specifies the type or types of service for which the discount and special rate is to apply; destination prefix field 104 identifies the destination number for which the discount rate is to apply, rate class field 106 defines the special rate and percentage discount field 108 defines the discount from the special rate.

FIG. 5D shows the format of a data record entry for providing a third party charging scheme. Service type field 110 specifies the type or types of service for which the third party charging scheme is to apply, destination prefix field 112 identifies the destination prefixes or numbers for which third party will accept charges; percentage discount field 114 defines the percentage of the call cost to be charged to the third party; and additional chargeable party 116 identifies the third party to whom at least a part of the charges are to be levied. Of course, the percentage may be 100% in which case the third party is charged for the whole cost of the call or service and the prepaid subscriber is not charged at all.

FIG. 5E shows the format of three data record entries for providing a restricted calling list. Entry 118 starts by restricting calls to all numbers by specifying all possible service types and all destination prefixes and by specifying a rate class of “−1” to indicate the restriction. Then, entry 120 specifies a rate class for certain service types and destination prefixes which are to be allowed and entry 122 specifies a rate class for certain service types and destination numbers which are also to be allowed.

It will be appreciated that other types of rating or handling schemes may be implemented according to the present invention and that data record entries other than those illustrated above may be used. Combinations of any number of data record entries may be used to provide a highly personalised rating or handling scheme. Furthermore, data formats other than that described in relation to FIGS. 3 and 5A to 5E may be used. In general, fields representing any parameters relating to a service, subscription, subscriber, time of day, date, network, one or more other chargeable parties, and one or more apportionments of rates, discounts or charges may be included. For example, a field may be included relating to the geographic location of the user (whether identified by cell D, Global Positioning System (GPS) co-ordinates, location data generated by a network location server or otherwise) thus enabling rating of calls to be determined in part by the geographical location of the subscriber.

It will also be appreciated that rating data determined in accordance with the present invention will, in general, be only part of the rating data used to rate a service. Thus, rating of a service, such as a call subject to a “lo-call discount”, will in general depend not only on rating data determined using personalised rating data records, such as an overriding rate class, but also on other rating data, such as the time of day, date, type of subscription etc. In the present invention, as defined in the accompanying claims, the term “rating data” is not limited to all the data for use in rating a service, but denotes at least part of the data for use in rating a service.

Furthermore, two or more prepaid subscribers, with separate prepaid account balances, may share a single personalised rating information list by means of subscriber aliasing within SDF 20. Similarly, two or more subscribers, with separate personalised rating information lists, may share a single prepaid account balance by means of subscriber aliasing within SDF 20. Indeed, two or more prepaid subscribers may share a single personalised rating information list and a single prepaid account balance by means of subscriber aliasing within SDF 20.

While it has been described above how personalised rating information may be used to handle or rate services provided to prepaid subscribers, it will be apparent that the present invention is equally applicable to postpay or contractual subscribers of telecommunications networks. In this respect, CDRs (or Service Detail Records) generated after provision of a call or service may be periodically sent in batches to a processor for determining rating data in accordance with the present invention. The rating data may be determined on the basis of the information concerning the call or service contained in the CDR and on the basis of personalised rating information maintained in respect of the subscriber, if any. The determined rating data in respect of a CDR may added to or associated with that CDR for sending to a rating processor for rating the call or service. Typically this will occur in batch mode as well. The rated CDRs output from the rating processor may then be sent to a billing processor for generating subscriber bills. Thus, rating data, for rating a batch of calls or services on the basis of personalised rating information held for a subscriber, may be determined periodically, at any time prior to actual rating which itself may be performed at any time prior to bill generation.

One disadvantage of determining rating data periodically in batch mode prior to rating and billing is that personalised rating information may be dynamic. Thus, the personalised rating information may change one or more times within a single billing period and rating may need to be performed in respect of historical personalised rating information. This requires the telecommunications network operator to maintain a historic database of personalised rating information for each subscriber and to implement relatively complex processes to determine rating data which take historical personalised rating information into account. This is undesirable. Preferably, rating data for use in rating a call or service is determined in “real-time”—that is during processing of the service request, during provision of the service or soon after provision of the service—on the basis of a current database of personalised rating information. This determined rating data may be added to or associated with a CDR (or SDR) generated for the call or service provided. However, the rating process, and subsequent the billing process, may take place periodically as with conventional rating and billing systems for postpay or contractual subscribers. Thus, a historical database of personalised rating information need not be maintained for subscribers and the rating process is simplified.

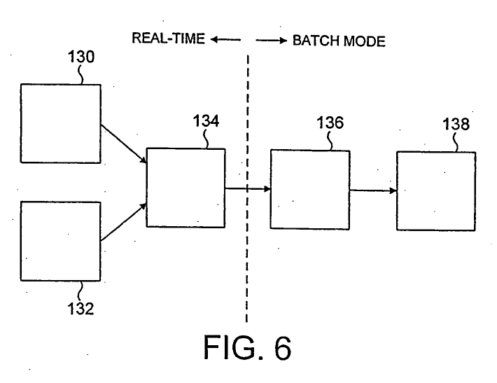

FIG. 6 shows an exemplary data flow for the preferred embodiment described above in which rating data for use in rating a call or service is determined in “real-time” although actual rating and billing processes is performed in batch mode. Rating data 130 for use in rating the call or service is determined on the basis of information about the call or service requested or provided and on the basis of current personalised rating information maintained for the subscriber. The current personalised rating information may be maintained in a database function such as SDF 20 as described above in relation to prepaid embodiments of the present invention. The data processing steps required to determine rating data 130 may similarly be performed as described above in relation to prepaid embodiments of the present invention. For instance, the information about the call or service may be provided in a service request message such as a Determine_Call_Action INAP message sent Alternatively, instance data relating to the call or service being currently provided or a CDR (or SDR) generated after the call or service has been provided may be used. Thus, rating data 130 may be generated during processing of a service request, during provision of a service or soon after a service has been provided.

A CDR (or SDR) 132 is generated in a conventional manner upon completion of the call or service provided. For example, for a chargeable voice call, CDR 132 may contain information such as the subscriber account or telephone number (MSISDN), the originally called number, the: chargeable destination number, the start of call date and time, the end of call date and time, and so on. Determined rating data is then added to CDR 132 to form augmented CDR 134. Augmented CDR 134 is temporarily stored and subsequently sent to a rating processor for rating the call or service at least in part on the basis of the determined rating data contained in augmented CDR 134, thus generating rated CDR 136. The rating may be performed in batch mode at any time prior to generation of a periodic bill for the call. Rated CDR 136 is then sent to a billing engine for generation of billing data 138. Again, generation of billing data may be performed in batch mode. Preferably, rating and generation of billing data are performed once in every periodic billing cycle. In an alternative embodiment, rating data 130 and CDR 132 may be temporarily stored and subsequently sent to a rating processor for rating the call or service without generating augmented CDR 134.

In accordance with other embodiments of the present invention, personalised rating information maintained in respect of a subscriber may be determined dynamically at least in part by the telecommunications network. Data records for implementing a particular rating scheme for a subscriber may be stored in a database function such as SDF 20. However, data record entries may be determined dynamically by the telecommunications network on the basis of historical call or service usage by the subscriber. For instance, historical CDRs spanning a given period, such as a month, may be used to select the most called destination telephone numbers (whether in terms of number of calls or total cost). A predetermined number of the top destination numbers, such as the top 5, may then be used to generate “family and friends” entries for the subscriber which may be automatically included in the personalised rating information maintained for the subscriber in place of any existing “family and friends” entries. This process of selection of most used calls or services and automatic inclusion of personalised rating information for implementing a particular rating scheme for the subscriber may, in general, be performed periodically (such as once a day or once a month), may identify any set of call or service parameters for defining selected calls or services, and may include entries in respect of any type of rating scheme.

While it has been described above how the provision of telecommunications services may be handled and those services rated in accordance with personalised rating information, and with particular reference to telephony calls and SMS messages, it is to be understood that the present invention is not limited to those types of telecommunications services, but is applicable to any type of telecommunications service. In this respect the destination prefix field of personalised rating data records maintained for a subscriber may contain any type of network address, such as an email address, IP address, domain name, top level domain name, Session Initiation Protocol (SIP) address and so on.

Furthermore, the present invention is also applicable to services offered by telecommunications network operators, but not themselves provided over the telecommunications network. For example, network operators may offer, as a telecommunications service, the possibility for subscribers to purchase physical goods or non-telecommunications services at personalised rates using the telecommunications network. In this respect the service type and/or destination prefix field of personalised rating data records maintained for a subscriber may contain special identifiers for a good or class of goods or a service or class of services for purchase over the telecommunications network. For example, an entry consisting of a so-called destination prefix of “CD purchase” along with a percentage discount of 10% may be used to personalise the purchase price for CDs for a given subscriber. Similarly, an entry consisting of a so-called destination prefix of “worldwide travel insurance purchase” along with a rate class of £10% per week may be used to personalise the purchase price of travel insurance for a given subscriber.

Also, it will be appreciated that technologies or protocols other than IN may be used to provide the control processing required to handle service requests in accordance with the present invention.

It will be also be appreciated that although the above embodiments have described the invention in relation to a second generation GSM network, the invention may be applied to the provision of any kind of telecommunications service in any kind of data telecommunications network whether fixed or mobile. With mobile networks, access may occur over circuit-switched data connections. Alternatively, access may occur over packet-switched channels using, for example, the General Packet Radio Service (GPRS), third generation packet-switched systems such as the Universal Mobile Telecommunications Service (UMTS), all-IP systems or systems based on Code Division or Time Division Multiplex Access (CDMA or TDMA). The Wireless Application Protocol (WAP) stack of protocols or Hypertext Transfer Protocol (HTTP) and Transmission Control Protocol over Internet Protocol (TCP/IP) may be used for data resource access, for example.

1. A computer-implemented method of determining rating data for use in rating a service requested to be provided to a subscriber of a telecommunications system, the method comprising the steps of:
storing individual subscriber records relating respectively to individual subscribers of a telecommunications system,
storing, in a subscriber record relating to a subscriber, information for use in determining rating data for use in rating a service requested to be provided to the subscriber, the information identifying one or more parameters of a service;
receiving a request to provide a service to the subscriber, and
determining rating data for use in rating the requested service in dependence on the information if one or more parameters of the service requested match the service parameters identified in the information.

2. A method according to claim 1, wherein the service parameters identified in the information comprise a type of service.

3. A method according to claim 1, wherein the service parameters identified in the information comprise a network address associated with the service, other than the network address of the subscriber.

4. A method according to claim 1, wherein the information identifies a specific rate for use in rating the service.

5. A method according to claim 1, wherein the information identifies a specific discount from a generally applicable rate for use in rating the service.

6. A method according to claim 1, wherein the information identifies a party, other than the subscriber, to whom at least part of a charge for providing the requested service is to be applied.

7. A method according to claim 1, wherein the determining is performed during processing of the service request, or during provision of the service.

8. A method according to claim 7, wherein the telecommunications system maintains an account balance for the subscriber and the method comprises generating charging data for applying to the subscriber's account balance in dependence on data including the determined rating data.

9. A method according to claim 8, wherein the charging data is generated and applied to the subscriber's account balance before or during provision of the requested service.

10. A method according to claim 6, wherein the telecommunications system maintains an account balance for the other party and the method comprises generating charging data for applying to the other party's account balance in dependence on data including the determined rating data.

11. A method according to claim 10, wherein the charging data is generated and applied to the other party's account balance before or during provision of the requested service.

12. A method according to claim 9, wherein when the requested service is a metered service, the method comprises determining a frequency for applying the charging data in dependence on data including the determined rating data.

13. A method according to claim 8, comprising the step of determining whether or not to provide or continue to provide the requested service to the subscriber in dependence on data including the determined rating data.

14. A method according to claim 8, comprising generating a message for sending to a terminal of the subscriber in dependence on data including the determined rating data.

15. A method according to claim 10, comprising generating a message for sending to a terminal of the other party in dependence on data including the determined rating data.

16. A method according to claim 15, wherein the message for sending to a terminal of the other party provides user interface means for determining whether or not to provide or continue to provide the requested service to the subscriber.

17. A method according to claim 8, wherein the data including the determined rating data further includes a value of the subscriber's account balance.

18. A method according to claim 10, wherein the data including the determined rating data further includes the other party's account balance.

19. Apparatus for performing the method of claim 1.

20. A computer program for performing the method of claim 1.

21. A data store for storing information for use in determining rating data for use in rating a service requested to be provided to a subscriber of a telecommunications system, the data store storing the information in individual subscriber records relating respectively to individual subscribers of a telecommunications system, the information identifying one or more parameters of a service and being for use in determining rating data for use in rating a service requested to be provided to the subscriber to which the information relates if one or more parameters of the requested service match the service parameters identified in the information.

22. A data store according to claim 21, wherein the service parameters identified in the information comprise a type of service.

23. A data store according to claim 21, wherein the service parameters identified in the information comprise a network address associated with the service, other than the network address of the subscriber.

24. A data store according to claim 21, wherein the information identifies a specific rate for use in rating the service.

25. A data store according to claim 21, wherein the information identifies a specific discount from a generally applicable rate for use in rating the service.

26. A data store according to claim 21, wherein the information identifies a party, other than the first subscriber, to whom at least part of a charge for providing the requested service is to be applied.

27. A data store according to claim 21, wherein the information is accessible from the data store during processing of the service request or during provision of the requested service.

28. A data processor for determining rating data for use in rating a service requested to be provided to a subscriber of a telecommunications system, the data processor comprising:
means for accessing information stored in individual subscriber records relating respectively to individual subscribers of a telecommunications system, one of the subscriber records comprising information for use in determining rating data for use in rating a service requested to be provided to a subscriber and identifying one or more parameters of a service;
means for receiving data relating to a service requested to be provided to the subscriber; and
means for determining rating data for rating the requested service in dependence on the information if one or more parameters of the service requested match the service parameters identified in the information.

29. A data processor according to claim 28, wherein the service parameters identified in the information comprise a type of service.

30. A data processor according to claim 28, wherein the service parameters identified in the information comprise a network address associated with the service, other than the network address of the subscriber.

31. A data processor according to claim 28, wherein the information identifies a specific rate for use in rating the service.

32. A data processor according to claim 28, wherein the information identifies a specific discount from a generally applicable rate for use in rating the service.

33. A data processor according to claim 28, wherein the information identifies a party, other than the subscriber, to whom at least part of a charge for providing the requested service is to be applied.

34. A data processor according to claim 28, wherein the means for determining is arranged to determine rating data during processing of the service request, or during provision of the service.

35. A data processor according to claim 34, wherein the telecommunications system is arranged to maintains an account balance for the subscriber and the data processor comprises means for generating charging data for applying to the subscriber's account balance in dependence on data including the determined rating data.

36. A data processor according to claim 35, wherein the charging data is generated and applied to the subscriber's account balance before or during provision of the requested service.

37. A data processor according to claim 33, wherein the telecommunications system is arranged to maintains an account balance for the other party and the data processor comprises means for generating charging data for applying to the other party's account balance in dependence on data including the determined rating data.

38. A data processor according to claim 37, wherein the charging data is generated and applied to the other party's account balance before or during provision of the requested service.

39. A data processor according to claim 36, wherein when the requested service is a metered service, the data processor is arranged to determines a frequency for applying the charging data in dependence on data including the determined rating data.

40. A data processor according to claim 35, wherein the telecommunications system comprises means for determining whether or not to provide or continue to provide the requested service to the subscriber in dependence on data including the determined rating data.

41. A data processor according to claim 35, wherein the telecommunications system comprises means for generating a message for sending to a terminal of the subscriber in dependence on data including the determined rating data.

42. A data processor according to claim 37, wherein the telecommunications system comprises means for generating a message for sending to a terminal of the other party in dependence on data including the determined rating data.

43. A data processor according to claim 42, wherein the message for sending to a terminal of the other party provides user interface means for determining whether or not to provide or continue to provide the requested service to the subscriber.

44. A data processor according to claim 35, wherein the data including the determined rating data further includes a value of the subscriber's account balance.

45. A data processor according to claim 37, wherein the data including the determined rating data further includes the other party's account balance.

46. A memory for storing data for access by a program being executed on a data processing system, the memory comprising:
a data structure stored in the memory, the data structure including information for use in determining rating data for use in rating a service requested to be provided to a subscriber of a telecommunications system, the information being stored in individual subscriber records relating respectively to individual subscribers of a telecommunications system, the information identifying one or more parameters of a service and being for use in determining rating data for use in rating a service requested to be provided to the subscriber to which the information relates if one or more parameters of the requested service match the service parameters identified in the information.

47. A memory according to claim 46, wherein the service parameters identified in the information comprise a type of service.

48. A memory according to claim 46, wherein the service parameters identified in the information comprise a network address associated with the service, other than the network address of the subscriber.

49. A memory according to claim 46, wherein the information identifies a specific rate for use in rating the service.

50. A memory according to claim 46, wherein the information identifies a specific discount from a generally applicable rate for use in rating the service.

51. A memory according to claim 46, wherein the information identifies a party, other than the first subscriber, for applying at least part of a charge for providing the requested service.

52. A memory according to claim 46, wherein the information is accessible from the data store during processing of the service request or during provision of the requested service.

53. A method of rating a service requested to be provided to a subscriber of a telecommunications system, the rating being performed on a per-subscriber basis, the method comprising the steps of:
selecting a subscriber of the telecommunications system;
selecting one or more parameters of a service which the telecommunications system is able to provide to the subscriber;
selecting rating data to be used when rating the service in respect of the subscriber;
generating information on the basis of the one or more parameters and the rating data;
providing a data store for storing individual subscriber records relating respectively to individual subscribers of the telecommunications system;
storing the information in a record of a data store relating to the selected subscriber;
receiving a service request to provide a service to the subscriber;
determining rating data for rating the requested service in dependence on the information if one or more parameters of the requested service match the one or more service parameters stored in the subscriber's record; and
rating the requested service in dependence on the determined rating data.

54. Apparatus for performing the method of claim 53.

55. A computer program for performing the method of claim 53.

56. A computer-implemented method of determining, on the basis of historical service provision, rating data for use in rating one or more services capable of being provided to a subscriber of a telecommunications system, the method comprising the following steps:
storing historical service provision data in respect of a subscriber of a telecommunications system;
selecting one or more services on the basis of a statistical analysis of historical service provision data for a first predetermined period;
determining one or more service parameters identifying the selected one or more services;
determining rating data for use in rating the selected one or more services during a second predetermined period, the determining being performed in dependence on the determined one or more service parameters.
